(19) United States
(12) Patent Application Publication
(10) Pub. No.: US 2024/0210797 A1
(43) Pub. Date: Jun. 27, 2024

(54) FILTER HOLDER AND FILTER ASSEMBLY

(71) Applicant: JIANGMEN PIXEL OPTICS CO., LTD., Jiangmen, Guangdong (CN)

(72) Inventor: SHIYONG HUANG, Jiangmen, Guangdong (CN)

(21) Appl. No.: 17/910,396

(22) PCT Filed: Dec. 8, 2021
(86) PCT No.: PCT/CN2021/136260

§ 371 Date: Sep. 9, 2022

(30) Foreign Application Priority Data
Jun. 24, 2021 (CN) 202121434936.7

(51) Int. Cl. G03B 17/14; G02B 7/00

(52) U.S. Cl. CPC G03B 17/14; G02B 7/006

(57) ABSTRACT

The present invention discloses a filter holder and a filter assembly. The filter holder comprises a filter frame, a magnetic attraction assembly, a lens fixing assembly and an adapter ring fixing piece, wherein the filter frame is provided with a lens mounting hole; the magnetic attraction assembly is located in the filter frame; the lens fixing assembly includes a first lens fixing piece and a second lens fixing piece, a lens mounting position is formed between the first lens fixing piece and the second lens fixing piece, and the first lens fixing piece is provided with a locking piece; a clamping groove is formed between the adapter ring fixing piece and the filter frame; a first filter lens is mounted in the lens mounting hole, and a second filter lens and a turning ring can be attracted through the magnetic attraction assembly; a side of an adapter ring is clamped through the clamping groove, the second filter lens is clamped through the first lens fixing piece and the second lens fixing piece, and the second filter lens is prevented from sliding through the locking piece; and the filter lens and the adapter ring can be stably mounted together to form the filter assembly.

### TECHNICAL FIELD

The present invention relates to the field of photographic equipment, and in particular to a filter holder and a filter assembly.

### BACKGROUND

A filter holder is a device mounted in front of a lens of photographic equipment and used to mount a filter lens. The current filter holder is provided with a magnetic body and is connected to a filter lens through magnetic attraction of the magnet, but the filter lens is prone to unstable mounting only through magnetic attraction connection. Once the filter lens slips from the mounting rack to the ground and is subjected to collision, the filter lens will be damaged.

### SUMMARY

Objectives of the present invention are to solve at least one of the technical problems in the prior art and provide a filter holder and a filter assembly.

The technical solutions used in the present invention to solve the problems are as follows:
according to a first aspect of the present invention, a filter holder comprises:
a filter frame, wherein the filter lens is provided with a lens mounting hole for mounting a first filter lens;
a magnetic attraction assembly, wherein the magnetic attraction assembly is located in the filter frame;
a lens fixing assembly, wherein the lens fixing assembly includes a first lens fixing piece and a second lens fixing piece, the first lens fixing piece and the second lens fixing piece are arranged on two sides of the filter frame respectively, a lens mounting position for mounting a second filter lens is formed between the first lens fixing piece and the second lens fixing piece, and the first lens fixing piece is provided with a locking piece for fixing the second filter lens;
an adapter ring fixing piece, wherein the adapter ring fixing piece is arranged on the filter frame, and a clamping groove for clamping an adapter ring is formed between the adapter ring fixing piece and the filter frame.

According to the first aspect, the filter frame is provided with a rotating mechanism for driving the first filter lens to rotate.

According to the first aspect of the present invention, the rotating mechanism includes a lens bearing frame and a gear, the lens bearing frame is located in the lens mounting hole, a tooth row is arranged on an outer side edge of the lens bearing frame, and the gear is in engaged connection with the tooth row.

According to the first aspect of the present invention, the adapter ring fixing piece is provided with a clamping arm, and a clamping protruded piece is arranged at one end, away from the filter frame, of the clamping arm.

According to the first aspect of the present invention, the filter frame is provided with a sliding groove, the adapter ring fixing piece is provided with a groove inserting piece, the groove inserting piece is inserted into the sliding groove, the sliding groove is provided with a spring, one end of the spring is connected to the groove inserting piece, and the other end of the spring is connected to a side groove wall, away from the lens mounting hole, of the sliding groove.

According to the first aspect of the present invention, the first lens fixing piece and the second lens fixing piece are both provided with embedding protruded pieces for being matched with track grooves of the second filter lens.

According to the first aspect of the present invention, the filter frame is provided with a threaded groove; the first lens fixing piece further includes a first vertical wall and a movable clamping piece; the first vertical wall is provided with a through hole for mounting, and the movable clamping piece is located in the through hole; and the locking piece is provided with a threaded foot, and the threaded foot penetrates through the movable clamping piece and is inserted into the threaded groove.

According to the first aspect of the present invention, the second lens fixing piece includes a second vertical wall arranged opposite to the first vertical wall.

According to the first aspect of the present invention, the magnetic attraction assembly includes a first magnetic body and a second magnet body, wherein the first magnetic body is arranged around the lens mounting hole, and the second magnetic body is located between the lens mounting hole and the first lens fixing piece, and is located between the lens mounting hole and the first lens fixing piece.

According to a second aspect of the present invention, a filter assembly includes a first filter lens, a second filter lens, an adapter ring and the filter holder according to the first aspect of the present invention, wherein the first filter lens is mounted in the lens mounting hole, the second filter lens is mounted at a lens mounting position, guide matching parts matched with a guide part are arranged on two sides of the second filter lens, and a side of the adapter ring is placed in a clamping groove.

The above solutions at least have the following beneficial effects: the first filter lens is mounted in the lens mounting hole, the second filter lens is mounted on a clamping position between the first lens fixing piece and the second lens fixing piece, the adapter ring is mounted on the filter frame, and the second filter lens and a turning ring may be attracted by the magnetic attraction assembly for fixation; in addition, the side of the adapter ring is clamped by the clamping groove for further fixation, the second filter lens is clamped jointly by the first lens fixing piece and the second lens fixing piece, and sliding of the second filter lens is prevented by the locking piece, so that the second filter lens is further fixed; and the filter lens and the adapter ring can be stably mounted together through the filter holder to form the filter assembly.

The additional aspects and the advantages of the present invention will be given in following description part, some of which will become obvious from the following description or be understood through the practice of the present invention.

### BRIEF DESCRIPTION OF DRAWINGS

The present invention is further described with reference to the accompanying drawings and examples.

FIG. 1 is a front structural diagram of a filter holder according to an embodiment of the present invention;

FIG. 2 is a back structural diagram of a filter holder according to an embodiment of the present invention;

FIG. 3 is an exploded view of a structure of a first lens fixing piece;

FIG. 4 is an exploded view of a structure of an adapter ring fixing piece;

FIG. 5 is an internal structural diagram of a filter holder according to an embodiment of the present invention;

FIG. 6 is a structural diagram of a filter assembly according to an embodiment of the present invention; and

FIG. 7 is an exploded view of a structure of a filter assembly according to an embodiment of the present invention.

### DETAILED DESCRIPTION OF EMBODIMENTS

The specific embodiments of the present invention are described below in detail. The preferred embodiments of the present invention are shown in the accompanying drawings. The accompanying drawings are used to supplement the description of the written part in the specification with figures, so that each technical feature and the overall technical solution of the present invention can be understood intuitively and vividly, but cannot be understood as a limitation to the protection scope of the present invention.

In the description of the present invention, it should be understood that orientation or position relationships indicated by terms such as “upper”, “lower”, “front”, “rear”, “left” and “right” related to the description of orientation are orientation or position relationships as shown in the drawings, and these terms are just used to facilitate description of the present invention and simplify the description, but not to indicate or imply that the mentioned device or elements must have a specific orientation and must be established and operated in a specific orientation, and thus, these terms cannot be understood as a limitation to the present invention.

In the description of the present invention, “several” means one or more, “a plurality of” means more than two, “greater than”, “less than”, “exceed” and the like are interpreted as excluding this number, and “above”, “below” and “within” are interpreted as including this number. If “first” and “second” are described, they are used only for distinguishing technical features, and shall not be interpreted as an indication or implication of relative importance or an implicit indication of the number of the indicated technical features or an implicit indication of the sequence of the indicated technical features.

In the description of the present invention, unless otherwise specified, words such as setting, mounting and connecting should be understood in a broad sense, and those skilled in the technical field may reasonably determine the specific meaning of the above words in the present invention in combination with the technical solution.

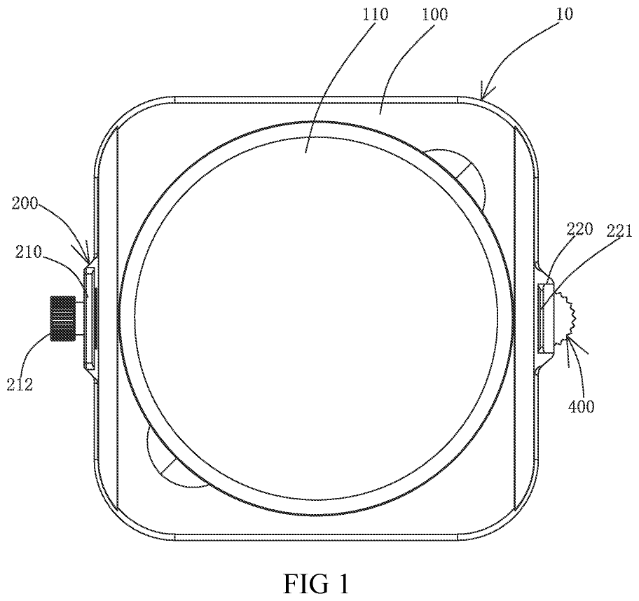

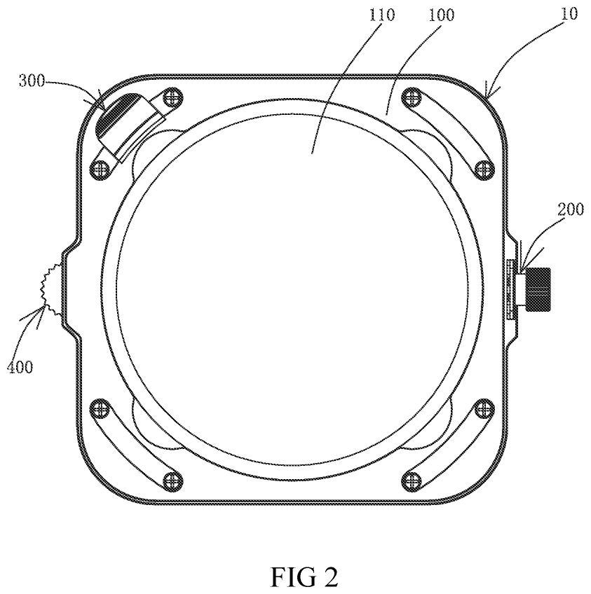

Referring to FIG. 1 and FIG. 2, in embodiments according to a first aspect of the present invention, a filter holder 10 is provided.

The filter holder 10 includes a filter frame 100, a magnetic attraction assembly 500, a lens fixing assembly 200 and an adapter ring fixing piece 300, wherein the filter frame 100 is provided with a lens mounting hole 110 for mounting a first filter lens 20; the magnetic attraction assembly 500 is located in the filter frame 100; the lens fixing assembly 200 includes a first lens fixing piece 210 and a second lens fixing piece 220, the first lens fixing piece 210 and the second lens fixing piece 220 are arranged on two sides of the filter frame 100 respectively, a lens mounting position for mounting a second filter lens 30 is formed between the first lens fixing piece 210 and the second lens fixing piece 220, and the first lens fixing piece 210 is provided with a locking piece 212 for fixing the second filter lens 30; and the adapter ring fixing piece 300 is arranged on the filter frame 100, and a clamping groove for clamping an adapter ring 40 is formed between the adapter ring fixing piece 300 and the filter frame 100.

In this embodiment, the first filter lens 20 is mounted in the lens mounting hole 110, the second filter lens 30 is mounted on a clamping position between the first lens fixing piece 210 and the second lens fixing piece 220, the adapter ring 40 is mounted on the filter frame 100, and the second filter lens 30 and a turning ring may be attracted by the magnetic attraction assembly 500 for fixation; in addition, the side of the adapter ring 40 is clamped by the clamping groove for further fixation, the second filter lens 30 is clamped jointly by the first lens fixing piece 210 and the second lens fixing piece 220, and sliding of the second filter lens 30 is prevented by the locking piece 212, so that the second filter lens 30 is further fixed; and the filter lens and the adapter ring 40 can be stably mounted together through the filter holder 10 to form a filter assembly.

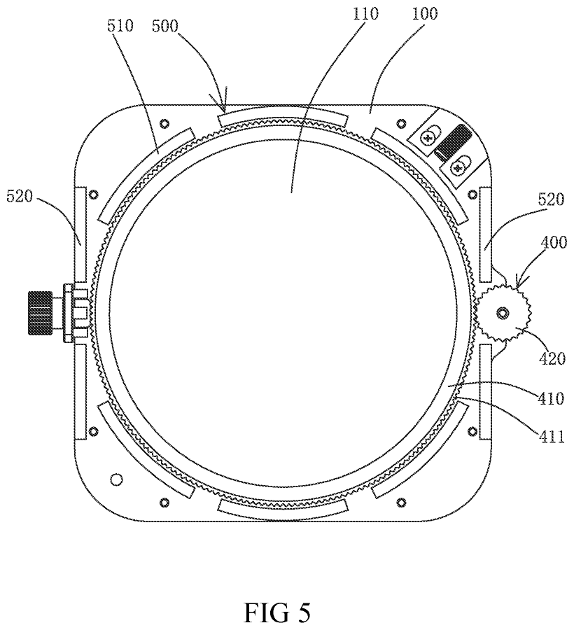

Referring to FIG. 5, in some embodiments according to the first aspect of the present invention, the filter frame 100 is provided with a rotating mechanism 400 for driving the first filter lens 20 to rotate. The first filter lens 20 can be driven conveniently by the rotating mechanism 400 to rotate in the lens mounting hole 110, so that the angle of the first filter lens 20 is adjusted.

In some embodiments according to the first aspect of the present invention, the rotating mechanism 400 includes a lens bearing frame 410 and a gear 420, wherein the lens bearing frame 410 is located in the lens mounting hole 110, a tooth row 411 is arranged on an outer side edge of the lens bearing frame 410, and the gear 420 is in engaged connection with the tooth row 411. The lens bearing frame 410 is provided with a round light-transmitting hole.

In this embodiment, the first filter lens 20 is placed in the lens bearing frame 410, the gear 420 is in engaged connection with the tooth row 411 of the lens bearing frame 410, and the lens bearing frame 410 and the first filter lens 20 thereon can be driven by the transmission gear 420 to rotate, so that the angle of the first filter lens 20 is adjusted. In addition, part of a rotating wheel extends out of the filter frame 100, so that it is convenient for a user to slide the rotating wheel, which extends out of the filter frame 100, with a finger so as to rotate the first filter lens 20.

Specifically, the gear 420 is located at a corresponding position of the second lens fixing piece 220, thereby facilitating a user to rotate.

Specifically, the circular first filter lens 20 corresponds to the circular lens mounting hole 110.

Referring to FIG. 4, in some embodiments according to the first aspect of the present invention, the adapter ring fixing piece 300 is provided with a clamping arm 310, and a clamping protruded piece 311 is arranged at one end, away from the filter frame 100, of the clamping arm 310. A clamping groove is formed between the clamping protruded piece 311 and the filter frame 100, and a side of the adapter ring 40 is clamped by the clamping groove for fixation.

In some embodiments according to the first aspect of the present invention, the filter frame 100 is provided with a sliding groove 330, the adapter ring fixing piece 300 is provided with a groove inserting piece 320, the groove inserting piece 320 is inserted into the sliding groove 330, the sliding groove 330 is provided with a spring 340, one end of the spring 340 is connected to the groove inserting piece 320, and the other end of the spring 340 is connected to a side groove wall, away from the lens mounting hole 110, of the sliding groove 330.

In this embodiment, the adapter ring fixing piece 300 can slide along the sliding groove 330 through cooperation between the groove inserting piece 320 and the sliding groove 330; and the spring 340 is connected between the groove inserting piece 320 and a side groove wall of the lens mounting hole 110, and the spring 340 applies an elastic force, which forces the adapter ring fixing piece 300 to move towards the lens mounting hole 110, to the adapter ring fixing piece 300.

The adapter ring fixing piece 300 slides away from the lens mounting hole 110, and at this time, the spring 340 is compressed by an external force; the position of the adapter ring 40 is initially fixed through the magnetic attraction assembly 500, then the adapter ring fixing piece 300 is released, and the adapter ring fixing piece 300 moves towards the adapter ring fixing piece 300 under the action of the spring 340 to clamp the adapter ring fixing piece 300.

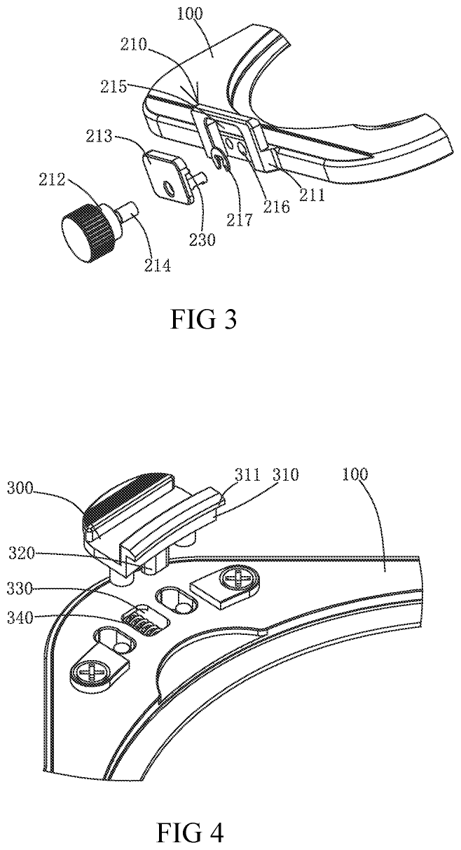

Referring to FIG. 1 and FIG. 3, in some embodiments according to the first aspect of the present invention, the first lens fixing piece 210 and the second lens fixing piece 220 are both provided with embedding protruded pieces 230 for being matched with track grooves 31 of the second filter lens 30. The track grooves 31 are formed at two sides of the second filter lens 30, the embedding protruded piece 230 of the first lens fixing piece 210 and the embedding protruded piece 230 of the second lens fixing piece 220 are embedded into the track grooves 31 on two sides of the second filter lens 30 in a one-to-one correspondence manner, so that the second filter lens 30 can slide along the track grooves 31.

Specifically, the second filter lens 30 is a square filter lens.

In some embodiments according to the first aspect of the present invention, the filter frame 100 is provided with a threaded groove 216, the first lens fixing piece 210 further includes a first vertical wall 211 and a movable clamping piece 213; the first vertical wall 211 is provided with a mounting through hole 215, and the movable clamping piece 213 is located in the mounting through hole 215; and the locking piece 212 is provided with a threaded foot 214. An elastic pad 217 is arranged between the movable clamping piece 213 and the filter frame 100, the elastic pad 217 is arranged at a corresponding position of the threaded groove 216, and the threaded foot 214 penetrates through the elastic pad 217 for fixation. The threaded foot 214 penetrates through the movable clamping piece 213 and the elastic pad 217 and is inserted into the threaded groove 216. Specifically, the embedding protruded piece 230 is arranged on one side, facing the second lens fixing piece 220, of the movable clamping piece 213. The movable clamping piece 213 is further provided with a plug, and the plug is inserted into a slot of the filter frame 100, so that the movable clamping piece 213 moves along an extending direction of the slot, where the extending direction of the slot is the same as an extending direction of the mounting through hole 215 of the first vertical wall 211.

In this embodiment, the second filter lens 30 is placed at a lens mounting position, the second filter lens 30 is slid to adjust the position of the second filter lens 30, and then the locking piece 212 is screwed towards the second filter lens 30, so that the locking piece 212 forces the movable clamping piece 213 to move towards the second filter lens 30, and the movable clamping piece 213 and the second lens fixing piece 220 jointly acts to stably fix the second filter lens 30, thereby preventing the second filter lens 30 from sliding.

In some embodiments according to the first aspect of the present invention, the second lens fixing piece 220 includes a second vertical wall 221 arranged opposite to the first vertical wall 211. Specifically, the embedding protruded piece 230 is arranged on one side, facing the first vertical wall 211, of the second vertical wall 221.

Referring to FIG. 5, in some embodiments according to the first aspect of the present invention, the magnetic attraction assembly 500 includes a first magnetic body 510 and a second magnetic body 520, wherein the first magnetic body 510 is arranged around the lens mounting hole 110; and the second magnetic body 520 is located between the lens mounting hole 110 and the first lens fixing piece 210, and is located between the lens mounting hole 110 and the first lens fixing piece 210.

In this embodiment, the first magnetic body 510 includes a plurality of arc-shaped magnets, which are arranged at intervals around the lens mounting hole 110 and form a ring shape, and the first magnetic body 510 is used to connect the adapter ring 40 in a magnetic attraction manner; and certainly, the first magnetic body 510 can also be used to connect the first filter lens 20 in the lens mounting hole 110 in a magnetic attraction manner. The second magnetic body 520 includes a plurality of straight strip-shaped magnets, wherein some of the straight strip-shaped magnets are arranged in a row sequentially in an end-to-end correspondence manner, and are located between the lens mounting hole 110 and the first lens fixing piece 210; some other straight strip-shaped magnets are arranged in another row sequentially in an end-to-end correspondence manner, and are located between the lens mounting hole 110 and the second lens fixing piece 220; and the two rows of straight strip-shaped magnets are used to connect the second filter lens 30 in a magnetic attraction manner.

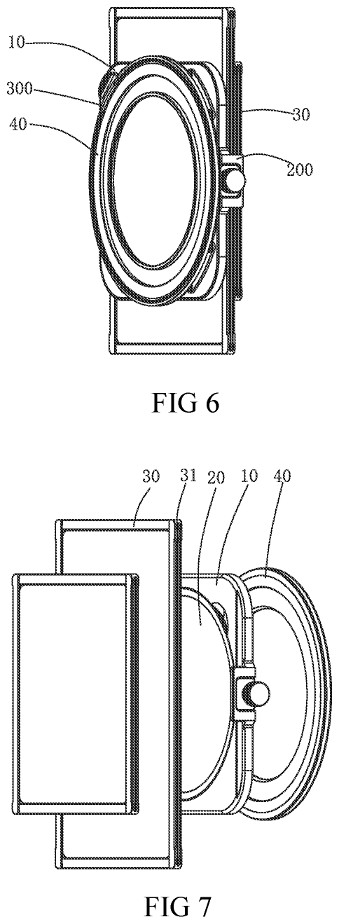

Referring to FIG. 6 and FIG. 7, in embodiments according to a second aspect of the present invention, a filter assembly is provided. The filter assembly includes a first filter lens 20, a second filter lens 30, an adapter ring 40 and the filter holder 10 as defined in the first aspect of the present invention, wherein the first filter lens 20 is mounted in the lens mounting hole 110, the second filter lens 30 is mounted at a lens mounting position, guide matching parts matched with a guide part are arranged on two sides of the second filter lens 30, and a side of the adapter ring 40 is placed in a clamping groove.

In this embodiment, the first filter lens 20 is mounted in the lens mounting hole 110, the second filter lens 30 is mounted on a clamping position between the first lens fixing piece 210 and the second lens fixing piece 220, the adapter ring 40 is mounted on the filter frame 100, and the second filter lens 30 and a turning ring may be attracted by the magnetic attraction assembly 500 for fixation; in addition, the side of the adapter ring 40 is clamped by the clamping groove for further fixation, the second filter lens 30 is clamped jointly by the first lens fixing piece 210 and the second lens fixing piece 220, and sliding of the second filter lens 30 is prevented by the locking piece 212, so that the second filter lens 30 is further fixed; and the filter lens and the adapter ring 40 can be stably mounted together through the filter holder 10 to form a filter assembly.

In some embodiments according to the second aspect of the present invention, the first filter lens 20, the second filter lens 30 and the adapter ring 40 are all provided with third magnetic bodies internally. Through cooperation between the third magnetic bodies and the magnetic attraction assembly 500, the first filter lens 20, the second filter lens 30 and the adapter ring 40 can be connected to the filter holder 10 in a magnetic attraction manner.

Specifically, the third magnetic body of the first filter lens 20 is a ring-shaped magnet formed by a plurality of arc-shaped magnets, and the plurality of arc-shaped magnets are arranged on an edge of the first filter lens 20. The third magnetic body of the second filter lens 30 is a straight strip-shaped magnet arranged on two sides of the second filter lens 30. The third magnetic body of the adapter ring 40 is a ring-shaped magnet formed by a plurality of arc-shaped magnets, and the plurality of arc-shaped magnets are arranged on an edge of the adapter ring 40.

It should be noted that there may be a plurality of second filter lenses 30. The plurality of filter lenses are jointly superposed and are placed between the first lens fixing piece 210 and the second lens fixing piece 220.

The above are only the preferred embodiments of the present invention, and the present invention is not limited to the above embodiments. As long as the embodiments can achieve the technical effects of the present invention with the same means, the embodiments should fall within the protection scope of the present invention.

What is claimed is:

1. A filter holder, comprising:
a filter frame, wherein the filter frame is provided with a lens mounting hole for mounting a first filter lens; a magnetic attraction assembly, wherein the magnetic attraction assembly is located in the filter frame; a lens fixing assembly, wherein the lens fixing assembly comprises a first lens fixing piece and a second lens fixing piece, the first lens fixing piece and the second lens fixing piece are arranged on two sides of the filter frame respectively, a lens mounting position for mounting a second filter lens is formed between the first lens fixing piece and the second lens fixing piece, and the first lens fixing piece is provided with a locking piece for fixing the second filter lens; and an adapter ring fixing piece, wherein the adapter ring fixing piece is arranged on the filter frame, and a clamping groove for clamping an adapter ring is formed between the adapter ring fixing piece and the filter frame.

2. The filter lens mounting frame according to claim 1, wherein the filter frame is provided with a rotating mechanism for driving the first filter lens to rotate.

3. The filter lens mounting frame according to claim 2, wherein the rotating mechanism comprises a lens bearing frame and a gear, the lens bearing frame is located in the lens mounting hole, a tooth row is arranged on an outer side edge of the lens bearing frame, and the gear is in engaged connection with the tooth row.

4. The filter lens mounting frame according to claim 1, wherein the adapter ring fixing piece is provided with a clamping arm, and a clamping protruded piece is arranged at one end, away from the filter frame, of the clamping arm.

5. The filter lens mounting frame according to claim 4, wherein the filter frame is provided with a sliding groove, the adapter ring fixing piece is provided with a groove inserting piece, the groove inserting piece is inserted into the sliding groove, the sliding groove is provided with a spring, one end of the spring is connected to the groove inserting piece, and the other end of the spring is connected to a side groove wall, away from the lens mounting hole, of the sliding groove.

6. The filter lens mounting frame according to claim 1, wherein the first lens fixing piece and the second lens fixing piece are both provided with embedding protruded pieces for being matched with track grooves of the second filter lens.

7. The filter lens mounting frame according to claim 1, wherein the filter frame is provided with a threaded groove; the first lens fixing piece further comprises a first vertical wall and a movable clamping piece; the first vertical wall is provided with a through hole for mounting, and the movable clamping piece is located in the through hole; and the locking piece is provided with a threaded foot, and the threaded foot penetrates through the movable clamping piece and is inserted into the threaded groove.

8. The filter lens mounting frame according to claim 7, wherein the second lens fixing piece comprises a second vertical wall arranged opposite to the first vertical wall.

9. The filter lens mounting frame according to claim 1, wherein the magnetic attraction assembly comprises a first magnetic body and a second magnet body, wherein the first magnetic body is arranged around the lens mounting hole, and the second magnetic body is located between the lens mounting hole and the first lens fixing piece, and is located between the lens mounting hole and the first lens fixing piece.

10. A filter assembly, comprising a first filter lens, a second filter lens, an adapter ring and the filter holder according to any one of claims 1 to 9, wherein the first filter lens is mounted in the lens mounting hole, the second filter lens is mounted at a lens mounting position, and a side of the adapter ring is placed in a clamping groove.
